(19) United States
(12) Patent Application Publication
(10) Pub. No.: US 2015/0278023 A1
(43) Pub. Date: Oct. 1, 2015

(54) APPARATUS AND METHOD FOR RECOVERING DATA IN ORACLE DATABASE

(71) Applicant: KOREA UNIVERSITY RESEARCH AND BUSINESS FOUNDATION, Seoul (KR)

(72) Inventors: Sang Jin LEE, Seoul (KR); Jong-Hyun Choi, Seoul (KR); Kuk Heon Lee, Seoul (KR); Doo Won Jeong, Seoul (KR)

(73) Assignee: KOREA UNIVERSITY RESEARCH AND BUSINESS FOUNDATION, Seoul (KR)

(21) Appl. No.: 14/666,995

(22) Filed: Mar. 24, 2015

(30) Foreign Application Priority Data
Mar. 28, 2014 (KR) 10-2014-0036547

(51) Int. Cl. G06F 11/14; G06F 17/30

(52) U.S. Cl. CPC G06F 11/1412; G06F 17/30339; G06F 17/30563

(57) ABSTRACT

Provided is an apparatus and method for recovering data in an oracle database, in which the data restoring apparatus receives a system file from a database, inquires a system table included in the system file to deduct schema information about at least one table in the system file, sorts a deleted table among the at least one table based on the schema information, searches and deducts a data block including the deleted record by means of an object ID of the sorted table, and identifies and extracts the deleted record from the deducted data block to restore the deleted record.

### CROSS-REFERENCE TO RELATED APPLICATIONS

This application claims priority under 35 U.S.C. §119 to Korean Patent Application No. 10-2014-0036547 filed on Mar. 28, 2014 in the Korean Intellectual Property Office, the disclosure of which is incorporated herein by reference in its entirety.

### TECHNICAL FIELD

The following disclosure relates to a method for recovering data in an oracle database, and in particular, to a method for restoring table schema information and deleted record from a database file independently from a transaction log file.

### BACKGROUND

Generally, an organization uses a database to integrally manage an extensive amount of data, and thus in many cases, important information such as business data and personal data is stored in the database. Thus, it is very likely that meaningful information remains therein, and thus it can be understood that the database is an important object of investigation in a digital forensic aspect.

It is important to extract normal record from a database, and it is also important to recover deleted records. By recovering deleted record, behaviors of a user may be reconstituted, and intended destruction of evidence by a suspect may be coped with, which may give a huge help in investigation.

A table space means a space of a database where actual data is physically stored. If the table space is analyzed, table data and table schema information of the database may be obtained. According to the IDC, an oracle database has a market share of 40.7% over the world and 60% in a domestic market.

In addition, the advanced research on database forensic has been focused in restoration of records based on a transaction log. P. Wright has proposed a method for tracking changes in an oracle database by using redolog and log miner (LogMiner) and restoring data at a previous point. In addition, Heloise Pieterse has arranged a technique for concealing data value, records or tables in a database by encoding, stripping or the like and also has emphasized the importance of the transaction log. Oluwasola Mary has showed that a query in a database can be expressed using algebra. Also, Oluwasola Mary has also expressed a query inversely and proposed a relational algebra log for storing the equation. Also, a technique for restoring previous data by using the log has been explained. Generally, when deleted records of an oracle database are restored, a DBF file and a transaction log should be present in pairs. In addition, deleted records are restored from an oracle database in operation by using a log miner. However, in this method, only a time point when a transaction log was recorded can be restored, and a time point when a transaction log was not recorded cannot be restored. In addition, among various modes for remaining a transaction log in an oracle database, there is a no-archive mode. In the no-archive mode, if a predetermined capacity is exceeded, an existing transaction log is overwritten, and thus data recovery may be available depending on oracle database operating environments or company policies.

Meanwhile, the related literature set forth below introduces a logical error restoring method of a database and proposes a technique for recovering data by using a transaction log. However, the related literature has a fatal drawback since recovery is available only through a transaction log.

In this point of view, it can be understood that there is needed a technical means capable of recovering deleted records from a database independently from a transaction log.

### RELATED LITERATURES

### Patent Literature

Korean Unexamined Patent Publication No. 10-2010-0134355 (Dec. 23, 2010)

### SUMMARY

Therefore, an embodiment of the present disclosure is directed to providing a method for restoring data independently from a transaction log by deducting schema information from the database and then extracting deleted records based on the deducted schema information.

Another embodiment of the present disclosure is directed to providing an apparatus for restoring data independently from a transaction log by deducting schema information from the database and then extracting deleted records based on the deducted schema information.

In addition, the present disclosure is directed to providing a computer-readable recording medium on which a program for executing the above method in a computer is recorded.

In one general aspect, there is provided a method for restoring data, which includes: by an apparatus for restoring data (hereinafter, referred to as a data restoring apparatus), receiving a system file from a database; by the data restoring apparatus, inquiring a system table included in the system file to deduct schema information about at least one table in the system file; by the data restoring apparatus, sorting a deleted table among the at least one table based on the schema information; by the data restoring apparatus, searching and deducting a data block including the deleted record by means of an object ID of the sorted table; and by the data restoring apparatus, identifying and extracting the deleted record from the deducted data block to restore the deleted record.

In an embodiment, the database may be am oracle database.

In an embodiment, the deducting of schema information may include: by the data restoring apparatus, searching and deducting a table name OBJ$ and a table name C_OBJ# included in the system table; and by the data restoring apparatus, deducting the schema information according to flag values of the deducted table name OBJ$ and the deducted table name C_OBJ#.

In an embodiment, among the schema information, a table name, an object ID, and a table generation time may be deducted from the table name OBJ$.

In an embodiment, among the schema information, an object ID, a column name, a column data type, and size information of the table may be deducted from the table name C_OBJ#.

In an embodiment, the table may be a normal table when the schema information includes a flag value of 0x6C and be a deleted table when the schema information includes a flag value of 0x7C.

In an embodiment, the record may be a normal record, which is not deleted, when the record has a flag value of 0x2C, and the record may be a deleted record when the record has a flag value of 0x3C.

In another aspect, there is provided an apparatus for restoring data, which includes: an input unit for receiving a system file from a database; a processing unit for inquiring a system table included in the system file to deduct schema information about at least one table in the system file, sorting a table having a deleted record among the at least one table based on the schema information, and searching and deducting a data block including the deleted record by means of an object ID of the sorted table; and an extracting unit for identifying and extracting the deleted record from the deducted data block to restore the deleted record.

In an embodiment, the database may be an oracle database.

In an embodiment, the processing unit may search and deduct a table name OBJ$ and a table name C_OBJ# included in the system table, and the data restoring system may deduct the schema information according to flag values of the deducted table name OBJ$ and the deducted table name C_OBJ#. In addition, among the schema information, a table name, an object ID, and a table generation time may be deducted from the table name OBJ$, and among the schema information, an object ID, a column name, a column data type, and size information of the table may be deducted from the table name C_OBJ#.

In an embodiment, the table may be a normal table when the schema information includes a flag value of 0x6C and be a deleted table when the schema information includes a flag value of 0x7C.

In an embodiment, the record may be a normal record, which is not deleted, when the record has a flag value of 0x2C, and the record may be a deleted record when the record has a flag value of 0x3C.

In still another aspect, there is provided a computer-readable recording medium, on which a program for executing the data restoring method described above in a computer is recorded.

According to the present disclosure, schema information about at least one table is deducted from a system table to sort a table including deleted records, and a data block is accessed through an object ID of the sorted table to restore the deleted records. Therefore, during forensic investigation of the database, records at the time when a transaction log file is not present or a transaction log is not recorded may be restored.

### BRIEF DESCRIPTION OF THE DRAWINGS

FIG. 1 is a flowchart for illustrating a method for restoring data adopted in embodiments of the present disclosure.

FIG. 2a is a diagram showing records in a row data region of OBJ$ according to an embodiment of the present disclosure.

FIG. 2b is a diagram for illustrating a data storing method according to an embodiment of the present disclosure.

FIG. 2c is a diagram for illustrating a DATE data-type storing method according to an embodiment of the present disclosure.

FIG. 2d is a diagram showing record information obtained from OBJ$ according to an embodiment of the present disclosure.

FIG. 3 is a diagram showing a cluster of C_OBJ# according to an embodiment of the present disclosure.

FIG. 4a is a diagram showing a change of OBJ$ when a table is deleted according to an embodiment of the present disclosure.

FIG. 4b is a diagram showing a change of C_OBJ# when a table is deleted according to an embodiment of the present disclosure.

FIG. 5 is a diagram showing an “alert_database name.log” file according to an embodiment of the present disclosure.

FIG. 6a is a diagram showing a data block structure according to an embodiment of the present disclosure.

FIG. 6b is a diagram showing a data block header according to an embodiment of the present disclosure.

FIG. 6c is a diagram showing a row directory according to an embodiment of the present disclosure.

FIG. 6d is a diagram for illustrating a process of tracking record data in a row directory according to an embodiment of the present disclosure.

FIG. 7 is a diagram showing a change of row data after a record is deleted according to an embodiment of the present disclosure.

FIG. 8 is a diagram showing relations of OBJ$, C_OBJ# and a user table according to an embodiment of the present disclosure.

FIG. 9 is another flowchart for illustrating a data restoring method according to an embodiment of the present disclosure.

FIG. 10 is a diagram showing record insertion experiment results according to an embodiment of the present disclosure.

FIG. 11 is a block diagram showing an apparatus for restoring data adopted in embodiments of the present disclosure.

FIG. 12 is a diagram showing deleted record restoration experiment results according to an embodiment of the present disclosure.

### DETAILED DESCRIPTION OF EMBODIMENTS

Prior to explaining embodiments of the present disclosure, problems of an existing data restoring method will be reviewed, and then technical means adopted in embodiments of the present disclosure to solve the problems will be introduced in general.

Database stores important information, and is highly likely to be meaningful information in a digital forensic aspect. It is important to extract normal record from a database, and it is also important to recover deleted records. At the present, restoration of database data is studied based on a transaction log. However, this method has a fatal drawback since recovery is not available when a transaction log is not present or when data before a transaction log is recorded should be recovered.

Therefore, embodiments of the present disclosure are directed to providing a technical means capable of recovering deleted records of a database independently from a transaction log.

Hereinafter, embodiments of the present disclosure will be described in detail with reference to the accompanying drawings. However, in the following description and accompanying drawings, details of well-known features and techniques may be omitted to avoid unnecessarily obscuring the presented embodiments. In addition, throughout the overall drawings, like reference numerals denote like elements.

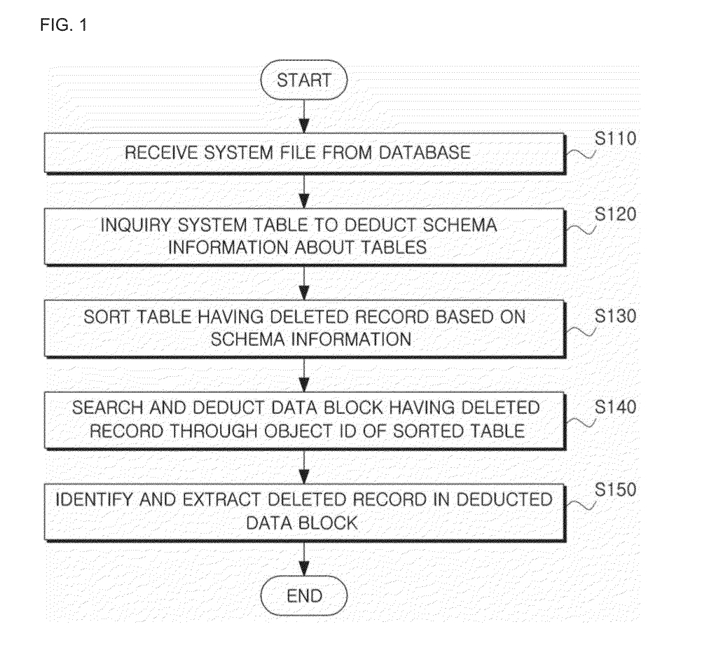

FIG. 1 is a flowchart for illustrating a method for restoring data (hereinafter, also referred to as a “data restoring method”) adopted in embodiments of the present disclosure. Here, an apparatus for restoring data (hereinafter, also referred to as a “data restoring apparatus”) receives a system file from a database, inquires a system table included in the system file to deduct schema information about at least one table in the system file, sorts a deleted table among the at least one table based on the schema information, searches and deducts a data block including the deleted record by means of an object ID of the sorted table, and identifies and extracts the deleted record from the deducted data block to restore the deleted record.

In more detail, in S110, the data restoring apparatus receives a system file from a database.

In other words, in order to restore a deleted record in an oracle database, a table space file structure should be known. The oracle table space includes TEMP, USER, SYSAUX, SYSTEM, EXAMPLE, and UNDOTBS, and each table space has a role as shown in Table 1 below.

TABLE 1

| Table space name | Description |
|---|---|
| TEMP | Store temporary table and index |
| | demanded for processing SQL |
| USER | Store an object generated by a user |
| SYSAUX | Store system information |
| SYSTEM | Store a data dictionary |
| EXAMPLE | Store a sample schema |
| UNDOTBS | Store Undo information |

Among them, a table space for storing tables and records is SYSTEM, and a table space for storing table information, table column information, or environment setting is also SYSTEM.

In S120, the data restoring apparatus inquires a system table included in the system file to deduct schema information about at least one table in the system file.

In other words, the data restoring apparatus may search and deduct a table name OBJ$ and a table name C_OBJ# included in the system table, and deduct the schema information according to flag values of the deducted table name OBJ$ and the deducted table name C_OBJ#. Here, among the schema information, a table name, an object ID, and a table generation time may be deducted from the table name OBJ$, and among the schema information, an object ID, a column name, a column data type, and size information of the table may be deducted from the table name C_OBJ#.

In more detail, in the oracle database, table information, table column information, or environment setting may be stored in a “SYSTEM.DBF” file which is the system table. Each system table has an inherent object ID. Therefore, if the object ID of the system table is known, schema information such as a table name and a table column name may be obtained. Here, among the system table, the table name OBJ$ and the table name C_OBJ# may allow schema information of the table to be obtained. In the OBJ$, the table name may be obtained, and in the C_OBJ#, the table column name, data type and data length information may be obtained. In addition, the OBJ$ and the C_OBJ# may include inherent object ID. The object ID may be as in Table 2 below.

TABLE 2

| Table name | Object ID |
|---|---|
| C_OBJ# | 2 |
| OBJ$ | 18 |

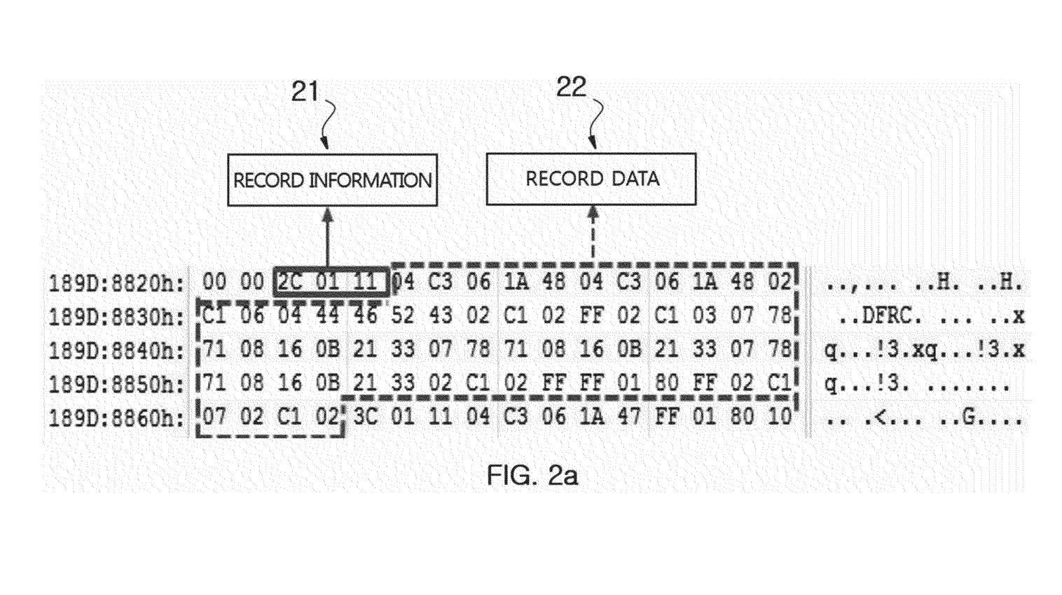

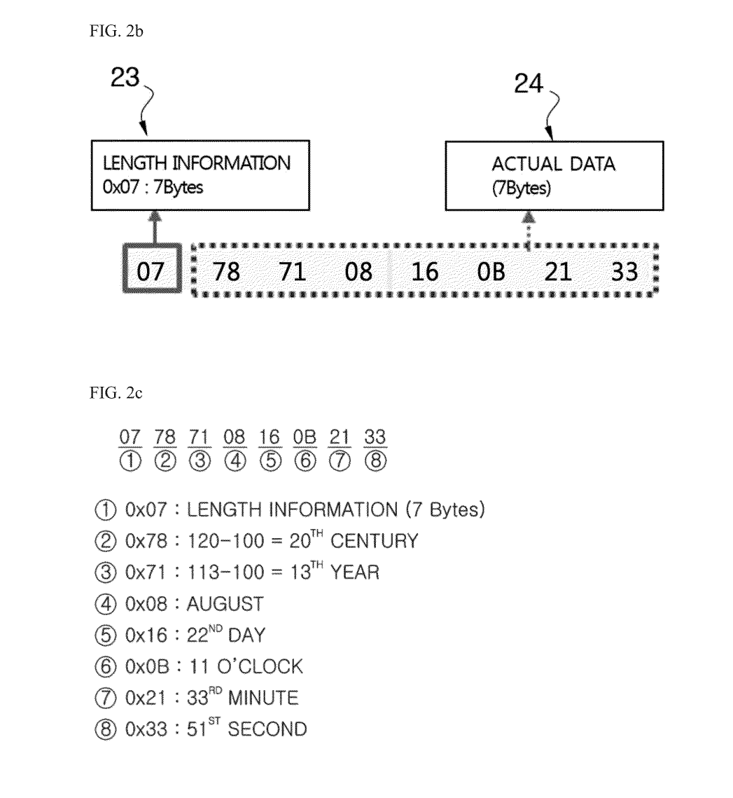

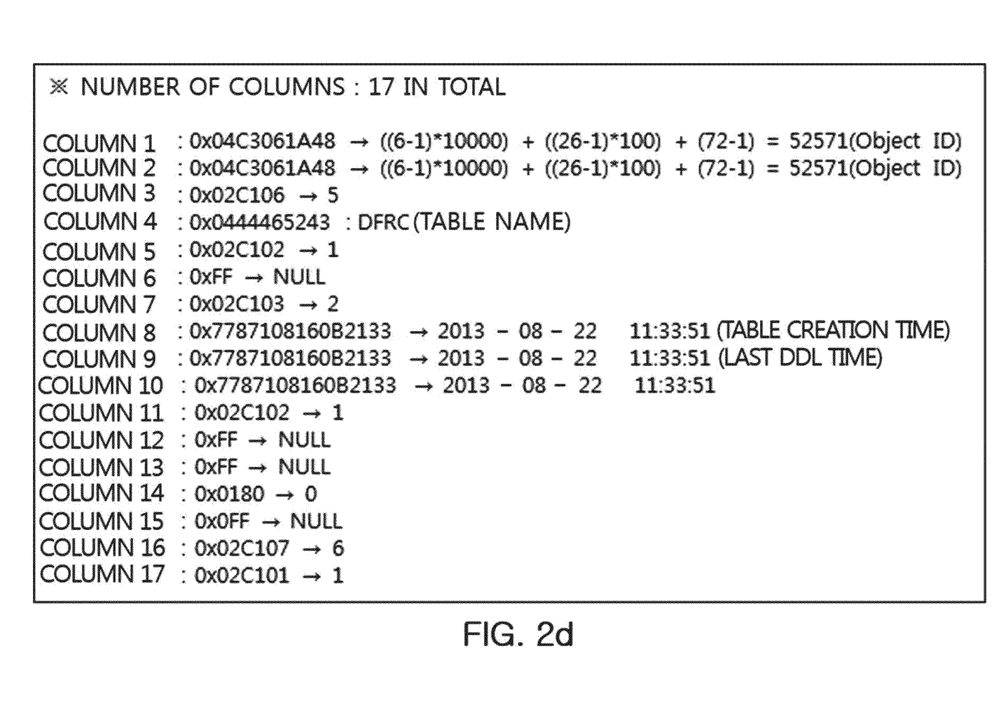

The schema information of the OBJ$ table may be found in the oracle official home page, and a table name, an object ID and a table generation time may be found in the OBJ$ table. Here, the process of obtaining schema information from the OBJ$ table will be described in more detail below with reference to FIGS. 2a to 2d.

FIG. 2a is a diagram showing records in a row data region of OBJ$ according to an embodiment of the present disclosure, in which the row data region is exemplarily depicted.

In more detail, the schema information of the OBJ$ table may be found in the oracle official home page. In this table, a table name, an object ID and a table generation time may be found. In other words, in a record information region of row data, first three bytes may represent record information 21. A first byte may represent a state flag of the record, and a third byte may represent the number of columns. Therefore, since a third byte is 0x11 in FIG. 2a, it can be understood that there are 17 columns.

In addition, in a record data region 22, actual record data are stored. A storing method may differ depending on a data type supported by Oracle. In a basic structure, a first byte represents length information 23 of the corresponding column as shown in FIG. 2b. Since the first byte is 0x07 in FIG. 2b, it can be understood that data of 7 bytes are stored.

In addition, among oracle data types, a DATE data type is used for expressing date and time with a fixed length and may use 7 bytes. The DATE data type may store century, year, month, date, hour, minute and second by 1 byte, as shown in FIG. 2c. In addition, a NUMBER data type is used for storing number data having a variable length and may use 100 decimal numbers which occupy two digits in 1 byte.

In this way, in case of the record data 22 of FIG. 2a, column information may be obtained by using record length information 23 at its head. The obtained information may be arranged as shown in FIG. 2d.

FIG. 2d is a diagram showing record information obtained from OBJ$ according to an embodiment of the present disclosure. Here, by analyzing one record in the OBJ$ table, it is possible to know a table name, which is DFRC, a table generation and an object ID.

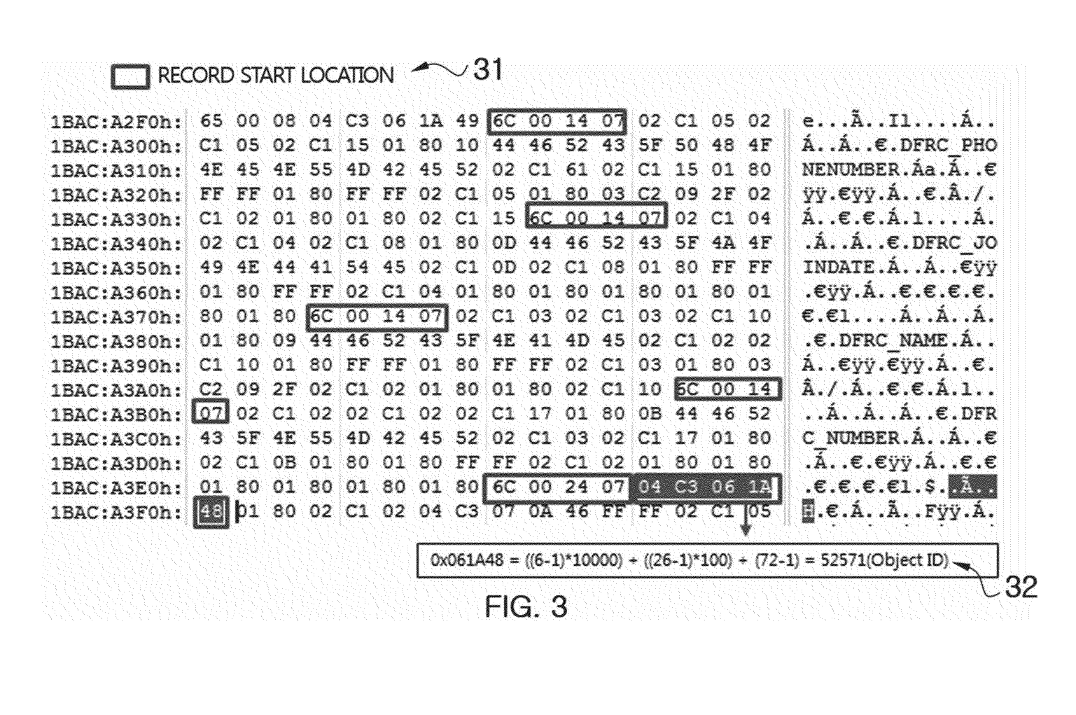

Meanwhile, the C_OBJ# may be a system duster. Here, the cluster is an oracle database object for storing several column information used in the table in a group. In the cluster, schema information such as an object ID, a column name, a column data type, size information or the like of the table may be obtained. Here, the C_OBJ# will be described in more detail below with reference to FIG. 3.

FIG. 3 is a diagram showing a cluster of C_OBJ# according to an embodiment of the present disclosure.

In more detail, FIG. 3 exemplarily depicts a cluster in the C_OBJ#, in which a record starting part 31 is marked, and an object ID 32 may be found in a lowermost block portion. In addition, seeing front portions of records in a single cluster, it can be found that fourth bytes are identical, which means the number of the cluster.

Main columns of the C_OBJ# may be as in Table 3 below.

TABLE 3

| Column order | Description |
|---|---|
| 1 | Column order |
| 5 | Column name |
| 6 | Data type |
| 7 | Data type length information |
| 9 | Precision of number data |
| 10 | Scale of number data |

Here, the sixth column of the C_OBJ# represents a data type, and an inherent value of each data type may be as in Table 4 below.

TABLE 4

| Value | Data type |
|---|---|
| 1 | VARCHAR2/NVARCHAR2 |
| 2 | NUMBER |
| 8 | LONG |
| 12 | DATE |
| 23 | RAW |
| 24 | LONG RAW |
| 69 | ROWID |
| 96 | CHAR/NCHAR |
| 112 | CLOB/NCLOB |
| 113 | BLOB |
| 114 | BFILE |
| 181 | TIMESTAMP |
| 182 | INTERVAL |
| 183 | INTERVAL |
| 208 | UROWID |
| 231 | TIMESTAMP |

Now, the process after S120 will be described with reference to FIG. 1 again.

In S130, the data restoring apparatus may sort a deleted table among the at least one table based on the schema information. In other words, if the schema information has a flag value of 0x6C, the table may be a normal table, and if the schema information has a flag value of 0x7C, the table may be a deleted table.

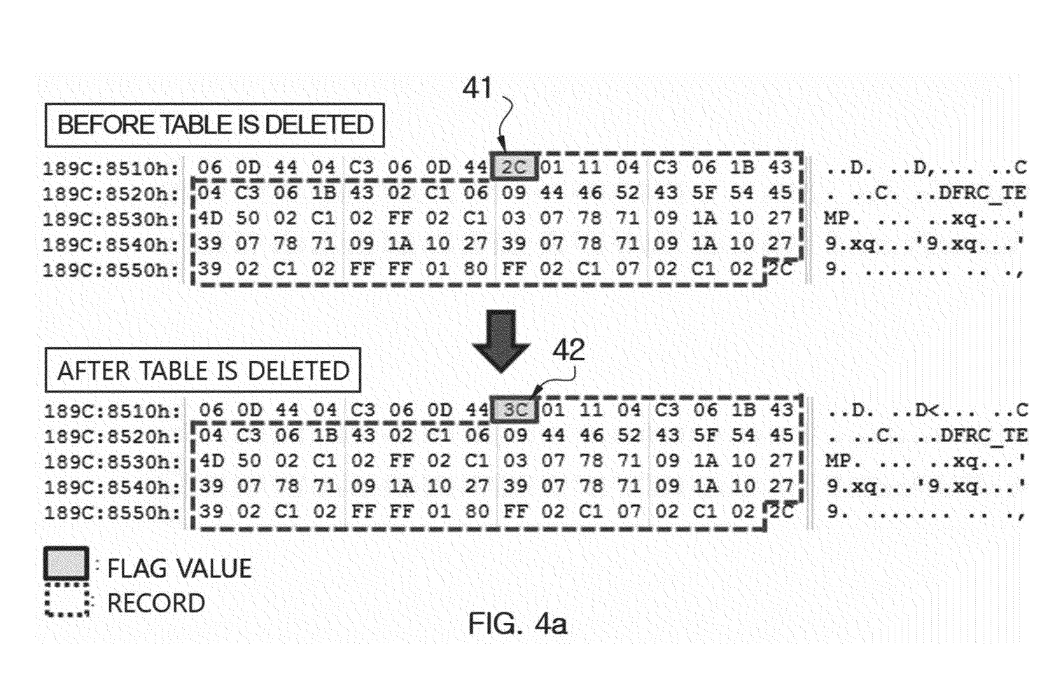

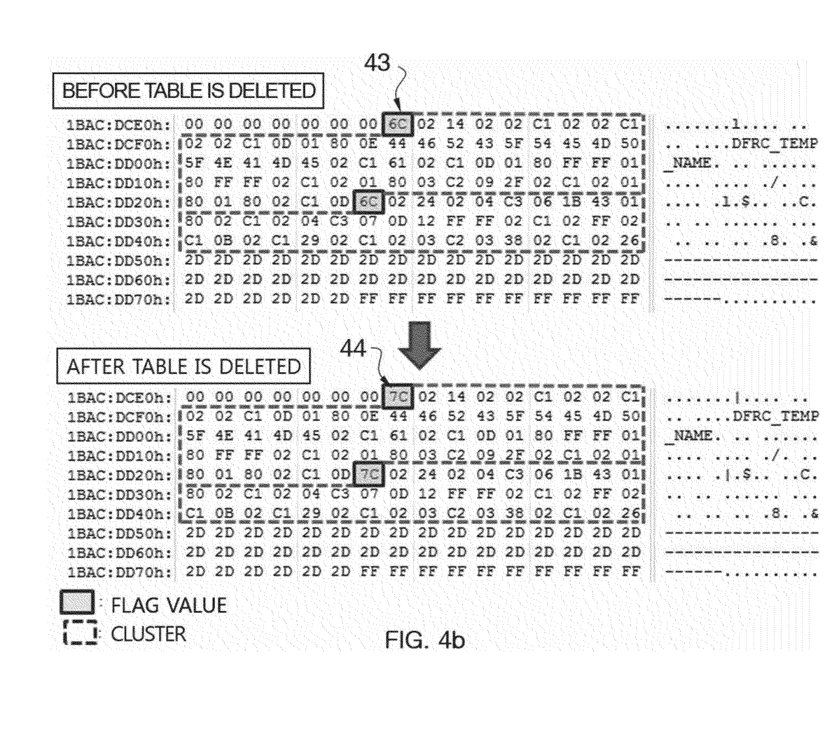

In more detail, when a table is deleted in an oracle database, in the OBJ$ table, it can be found that the flag value is 0x2C 41 before the table is deleted, and 0x3C 42 after the table is deleted, as shown in FIG. 4a.

In addition, in the C_OBJ# cluster, when a table is deleted as shown in FIG. 4b, it can be found that the flag value of the cluster is changed from 0x6C 43, before the table is deleted, into 0x7C 44, after the table is deleted.

Therefore, by comparing flag values included in the schema information, a table having a deleted record may be sorted.

Now, the process after S130 will be described with reference to FIG. 1 again.

In S140, the data restoring apparatus searches and deducts a data block including a deleted record by means of an object ID of the sorted table.

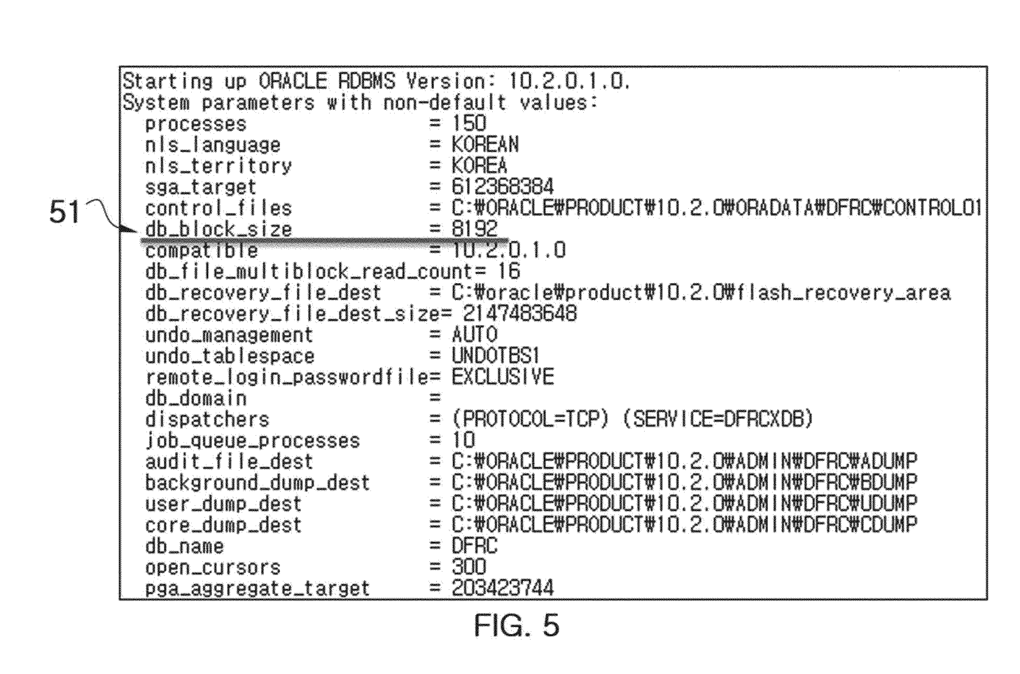

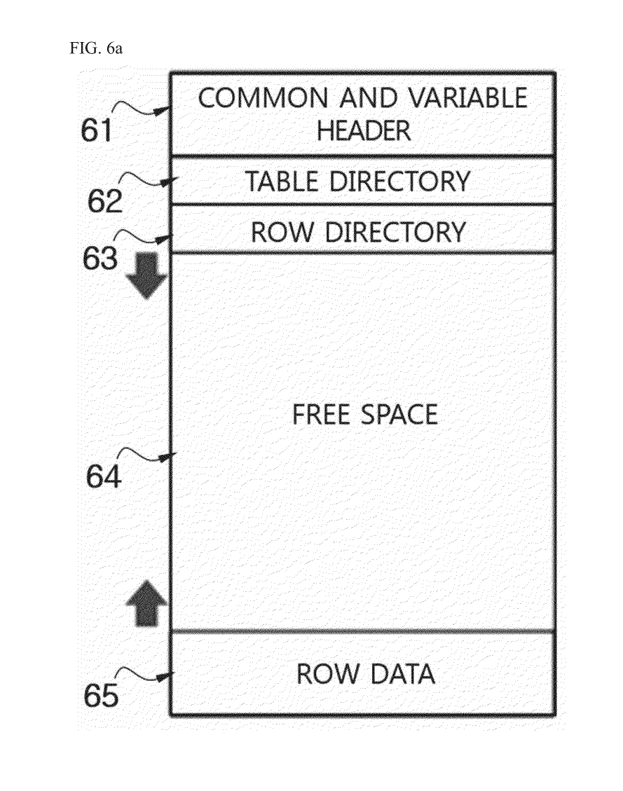

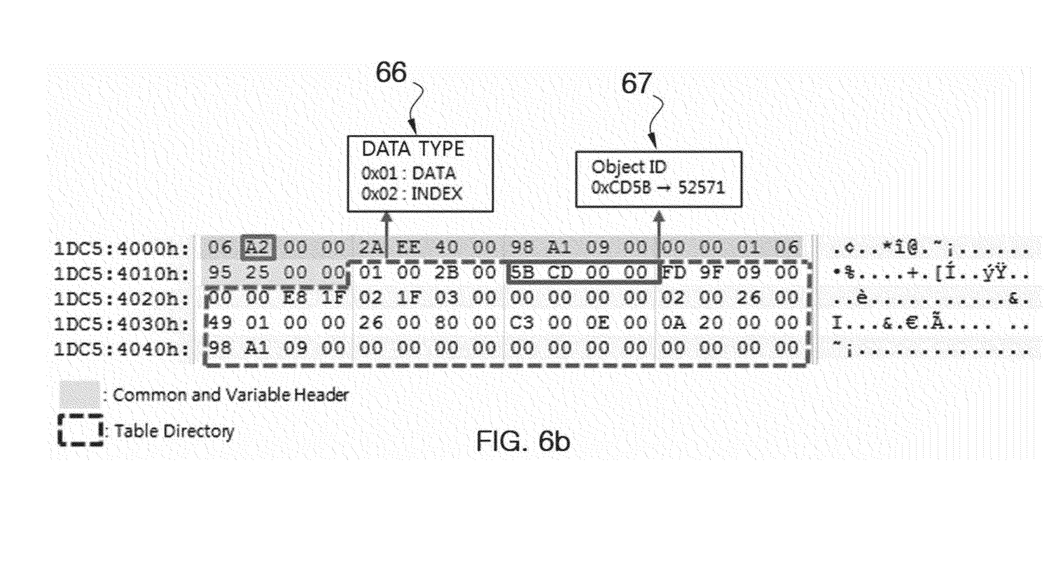

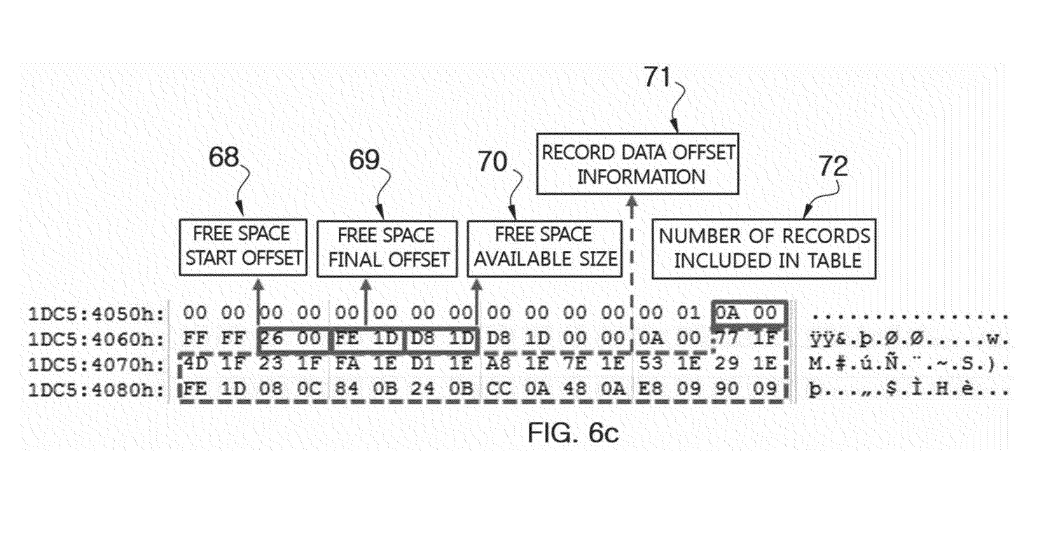

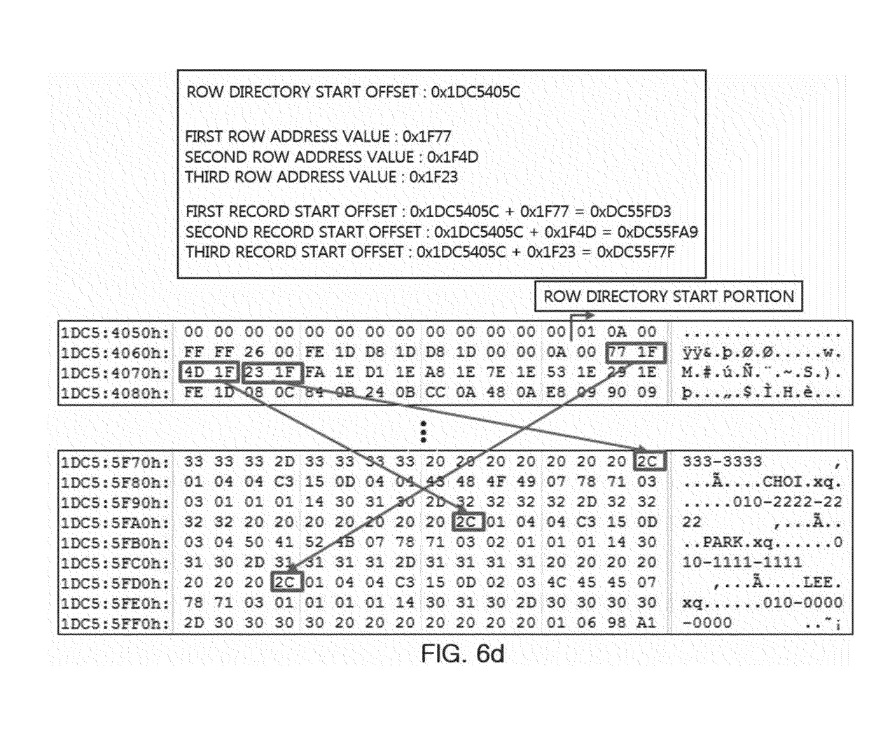

In more detail, prior to explaining S140, the data block will be described in detail. The table space has the data block, and the data block is a smallest storage unit used by the database, which may be an operation unit used for reading or writing data in the database. The size of the data block may be set when Oracle is installed, and the size cannot be changed in use. In addition, in the corresponding system, a block size may be checked through a database generation log. A basic path may be checked in “\admin\[database name]\bdump\alert_database name.log” in a directory where the oracle database is installed. FIG. 5 shows the alert_database name.log, and from an item “db_block_size” 51, it can be found that the data block has a size of 8192. Hereinafter, the structure of the data block will be described in more detail with reference to FIGS. 6a to 6d.

FIG. 6a is a diagram showing a data block structure according to an embodiment of the present disclosure, which includes a common and variable header 61, a table directory 62, a row directory 63, a free space 64 and row data 65. Here, in the data block, if records increases, a row directory 63 and a row data 65 also increase together, and as shown by the arrow in FIG. 6a, the row directory 63 may store data from the top of the data block, and the row data 65 may store data from the bottom of the data block. In addition, information obtainable from each element may be as listed in Table 5 below.

TABLE 5

| Element | Description |
|---|---|
| Common and Variable Header | Oracle version information |
| Table Directory | Data block type, Object ID |
| Row Directory | Number of records, Free Space size, |
| | Record offset information |
| Free Space | Free Space size |
| Row Data | Data |

FIG. 6b is a diagram showing a data block header according to an embodiment of the present disclosure, which depicts a common and variable header 61 and a table directory 62. Here, it can be found that the common and variable header 61 has a size of 20 bytes and is oracle version information.

In the table directory 62, a type 66 of the corresponding data block may be known. Here, it can be found that DATA is stored in case of 0x01, and INDEX is stored in case of 0x02. In addition, an object ID 67 may be known, and a table may be recognized by applying the object ID 67 to each object in an oracle table space. In FIG. 6b, the table has a value of 0xCD5B, and thus it can be known that the object ID is 52571.

FIG. 6c is a diagram showing a row directory according to an embodiment of the present disclosure. Here, in the row directory 63, it is possible to obtain a free space start offset 68 of the table, a free space final offset 69, a free space available size 70, record offset information 71, and a record number 72 of the table. In other words, the row directory 63 has record data offset information, which may be a distance from a start offset of the row directory 63. In FIG. 6c, the start offset of the row directory 63 is 0x1DC5405C and a first value is 0x1F77. Therefore, the sum of both of them is 0xDC55FD3, which thus may be a start location of the first record.

A location of each record may be calculated in this way, and FIG. 6d is a diagram exemplarily showing that locations of three records are tracked in a row directory.

Therefore, in S140, the object ID of the table sorted in S130 is compared with an object ID of each data block which may be checked through FIGS. 6a to 6d, thereby searching and deducing the same data block as the object ID of the sorted table.

Now, the process after S140 will be described with reference to FIG. 1 again.

In S150, the data restoring apparatus identifies and extracts the deleted record from the deducted data block to restore the deleted record. Here, if the record has a flag value of 0x2C, the record may be a normal record which is not deleted, and if the record has a flag value of 0x3C, the record may be a deleted record.

In more detail, when a record is deleted in an oracle database, the OBJ$ table and the C_OBJ# table are not changed, but only the data block storing the corresponding record is changed.

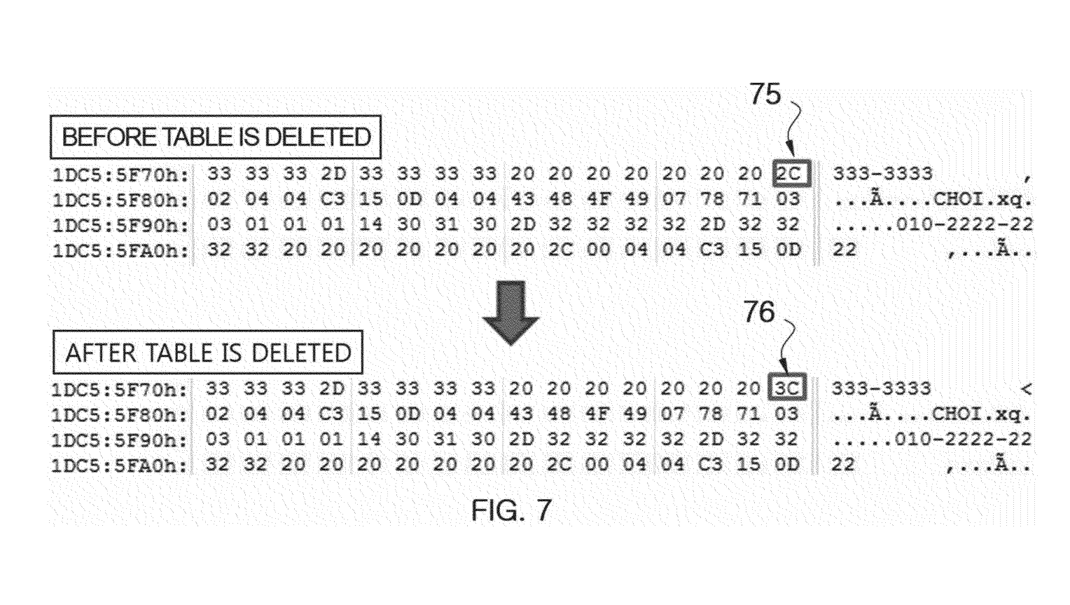

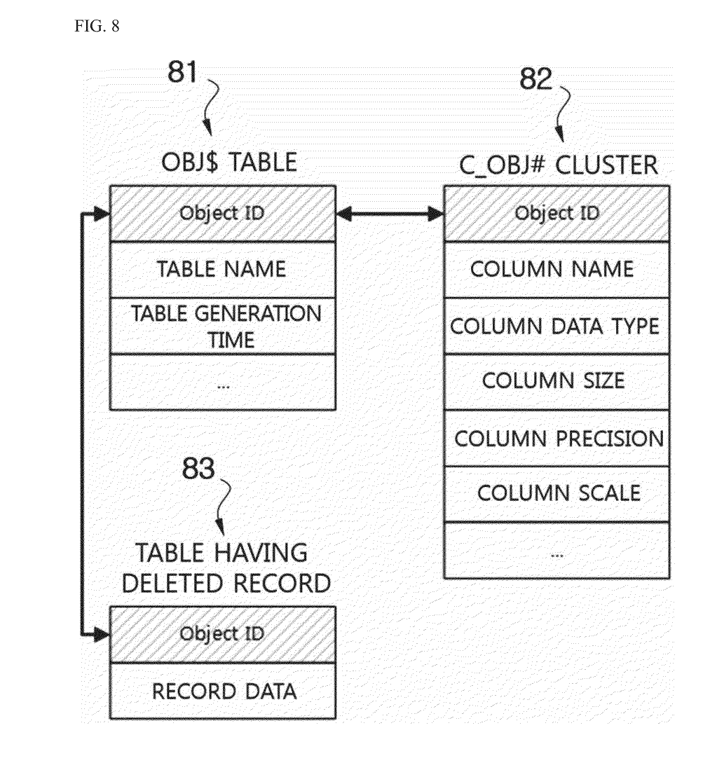

FIG. 7 is a diagram showing a change of row data after a record is deleted according to an embodiment of the present disclosure. From this, it can be found that a portion representing the record information is changed from 0x2C 75, before the record is deleted, into 0x3C 76, after the record is deleted.

Therefore, in the data block, a change of the portion representing the record information in the row data of FIG. 7 is checked to identify a record, which has been changed into 0x3C 75, as a deleted record, so that the corresponding record portion is extracted to recover the deleted record.

Meanwhile, it has been described that each of the OBJ$ table, the C_OBJ# cluster, and the table has an object ID, and table schema information and a table record may be obtained through the object ID. Their relationship diagram may be as shown in FIG. 8.

FIG. 8 is a diagram showing relations of OBJ$, C_OBJ# and a user table according to an embodiment of the present disclosure. In other words, object IDs of all tables in the oracle table space may be collected through the OBJ$ 81, a column name may be collected through the collected object ID in a C_OBJ# cluster 82, and through this process, it is possible to know schema information of a normal table and schema information of a deleted table 83.

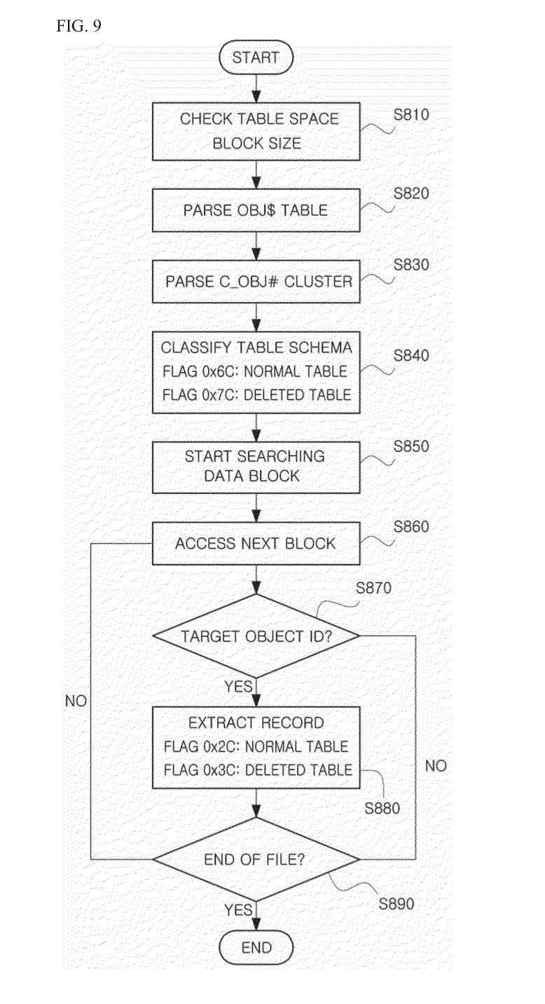

In addition, FIG. 9 is another flowchart for illustrating a data restoring method according to an embodiment of the present disclosure.

In more detail, in S810, in order to recover a deleted record, a block size of the table space should be known in advance. The block size may be found in an installation log file. If there is no log file, a block size should be found from an oracle type which represents an oracle version in the corresponding table space.

In S820, the OBJ$ table is parsed. In this process, the table name and the object ID may be known. At this time, if the flag value is 0x2C, the table is a normal table, and if the flag value is 0x3C, the table is a deleted table.

In S830, the C_OBJ# cluster is parsed. In this process, the object ID and the schema information of the table may be known. At this time, if the flag value is 0x6C, the information is schema information of a normal table, and if the flag value is 0x7C, the information is schema information of a deleted table.

In S840, the table schema is classified into a normal table and a deleted table based on the schema information obtained in S830.

In S850, the object ID is compared based on the schema information, and also blocks are searched.

In S860, data blocks are searched in order.

In S870, if a data block currently searched is compared with the target object ID and determined as being identical, the process proceeds to S880. If not, the process proceeds to S890.

In S880, if a data block currently searched is compared with the target object ID and determined as being identical, a record having a flag value of 0x3C is identified as a deleted record, and the corresponding record is extracted.

In S890, if a data block which is being currently searched is an end of the file, the process is completed, but if not, S860 to S890 are repeated.

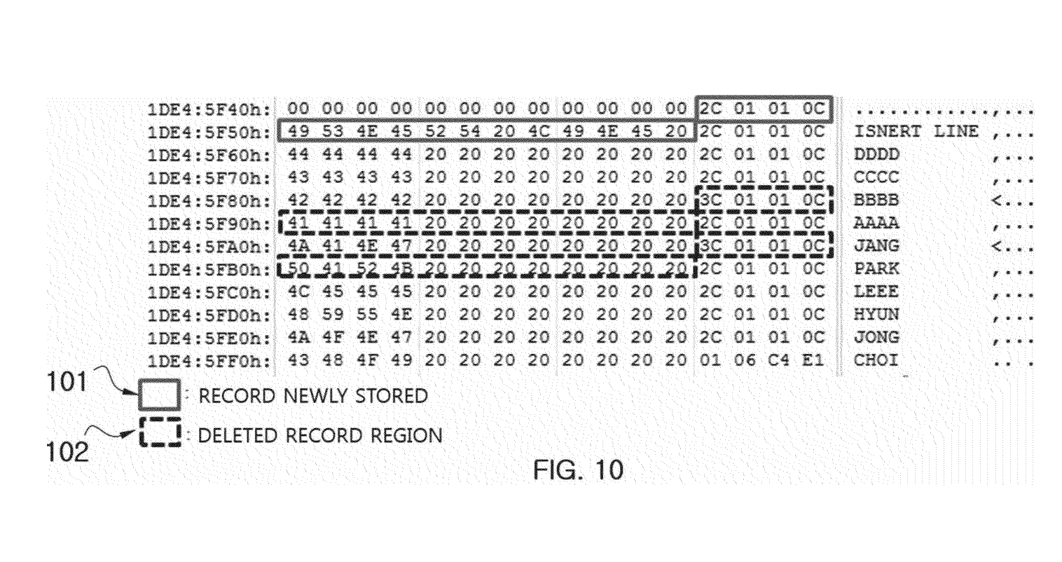

Meanwhile, when a record is deleted in a table, a region where the record is deleted is created in the data block. For example, it can be found that if a new record is stored by using an INSERT query as shown in FIG. 10, the new record is not stored in a deleted record region 102 but stored in a free space region 101. Through this, in the data restoring method proposed in the present disclosure, a deleted record may be restored even though a new record is stored after any record is deleted.

In addition, as explained above with reference to FIGS. 4a and 4b, when a table is deleted, a table name and schema information of the deleted table may be known from OBJ$ and C_OBJ#, and it can be found that the deleted table may be restored as long as the data block is overwritten.

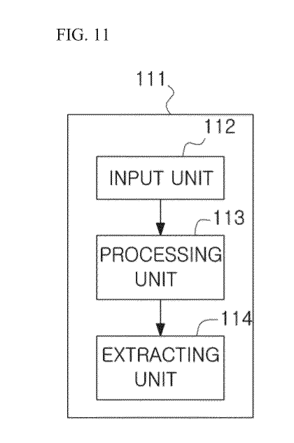

FIG. 11 is a block diagram showing an apparatus for restoring data (hereinafter, also referred to as a “data restoring apparatus”) adopted in embodiments of the present disclosure. Here, the data restoring apparatus 111 includes a component corresponding to each process of FIG. 1 described above. Therefore, in order to avoid duplicated explanation, functions of components of the system will be described in brief.

An input unit 112 receives a system file from a database.

A processing unit 113 inquires a system table included in the system file to deduct schema information about at least one table in the system file, sorts a deleted table among the at least one table based on the schema information, and searches and deducts a data block including the deleted record by means of an object ID of the sorted table.

An extracting unit 114 identifies and extracts the deleted record from the deducted data block to restore the deleted record.

In addition, the processing unit 113 searches and deducts a table name OBJ$ and a table name C_OBJ# included in the system table, and the data restoring system deducts the schema information according to flag values of the deducted table name OBJ$ and the deducted table name C_OBJ#. Here, among the schema information, a table name, an object ID, and a table generation time are deducted from the table name OBJ$, and among the schema information, an object ID, a column name, a column data type, and size information of the table are deducted from the table name C_OBJ#.

In addition, the table is a normal table when the schema information includes a flag value of 0x6C and is a deleted table when the schema information includes a flag value of 0x7C.

Moreover, the record is a normal record, which is not deleted, when the record has a flag value of 0x2C, and the record is a deleted record when the record has a flag value of 0x3C.

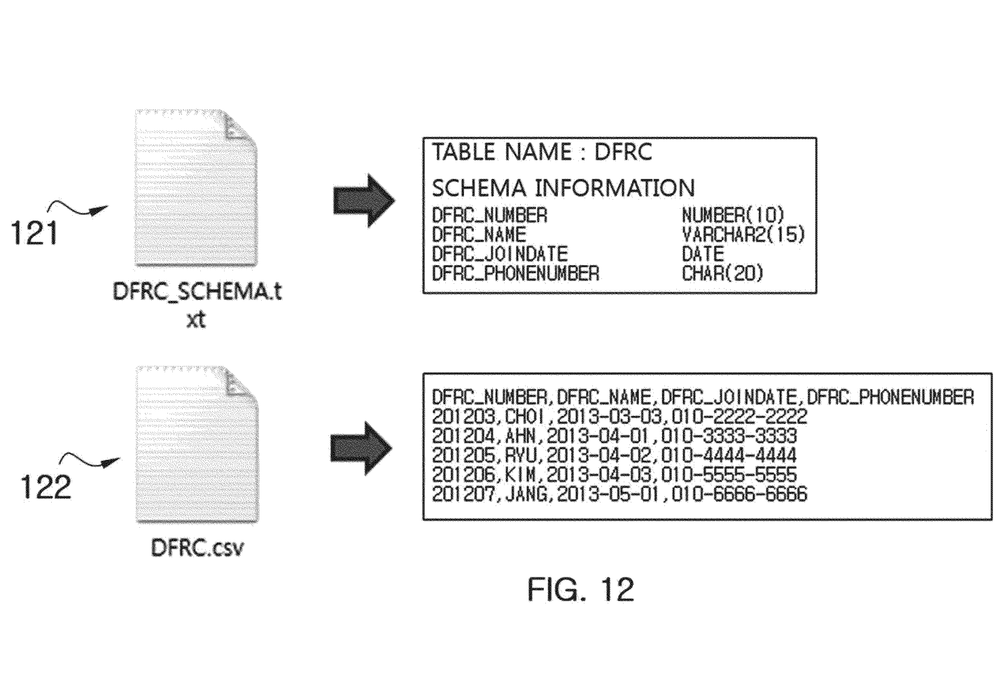

FIG. 12 is a diagram showing deleted record restoration experiment results according to an embodiment of the present disclosure. The experiments have been performed to 9i, 10g, 11g among various oracle versions in the Windows environment.

In more detail, a tool for restoring a deleted record has been implemented based on the data restoring method proposed in the present disclosure. Object IDs of all tables in an oracle table space are collected through OBJ$, and a column name is collected in the C_OBJ# cluster by means of the collected object ID. Through this process, it is possible to know schema information of a normal table and schema information of a deleted table 83. After that, a deleted record is recovered in a block having the collected object ID. Schema information 121 of the table and deleted record information 122 of the table are stored as different files in a CSV format.

As a result of experiment, all schema information of the deleted table has been recovered, but records have been restored only when the data block has not been overwritten.

According to the present disclosure, there is proposed a technique for restoring deleted tables and deleted records in a table space by means of OBJ$ and C_OBJ$ with respect to Oracle database which is most widely used in the world. In addition, through experiments, it is checked that deleted tables and deleted records are normally restored. Accordingly, during forensic investigation of the database, in case of restoring records at the time when a transaction log file is not present or a transaction log is not recorded, the method proposed in the present disclosure may give a help in extracting meaningful information.

Meanwhile, the embodiments of the present disclosure may be implemented as computer-readable codes recorded on a computer-readable recording medium. The computer-readable recording medium may include all kinds of recording devices capable of storing data.

The computer-readable recording medium includes, for example, ROM, RAM, CD-ROM, a magnetic tape, a floppy disk, optical data storage or the like. In addition, the computer-readable recording medium may be distributed to computer systems connected through a network so that the computer-readable codes are stored or executed in a distribution way. In, addition, functional programs, codes and code segments for implementing the present disclosure may be easily analogized by programmers in the field of the present disclosure.

While the exemplary embodiments have been shown and described, it will be understood by those skilled in the art that various changes in form and details may be made thereto without departing from the spirit and scope of this disclosure as defined by the appended claims. In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

### REFERENCE SYMBOLS

111: data restoring apparatus
112: input unit
113: processing unit
114: extracting unit

What is claimed is:

1. A method for restoring data, comprising:
by an apparatus for restoring data (hereinafter, referred to as a data restoring apparatus), receiving a system file from a database;
by the data restoring apparatus, inquiring a system table included in the system file to deduct schema information about at least one table in the system file;
by the data restoring apparatus, sorting a deleted table among the at least one table based on the schema information;
by the data restoring apparatus, searching and deducting a data block including the deleted record by means of an object ID of the sorted table; and
by the data restoring apparatus, identifying and extracting the deleted record from the deducted data block to restore the deleted record.

2. The method for restoring data according to claim 1,
wherein the database is an oracle database.

3. The method for restoring data according to claim 1, wherein said deducting of schema information includes:
by the data restoring apparatus, searching and deducting a table name OBJ$ and a table name C_OBJ# included in the system table; and
by the data restoring apparatus, deducting the schema information according to flag values of the deducted table name OBJ$ and the deducted table name C_OBJ#.

4. The method for restoring data according to claim 3,
wherein among the schema information, a table name, an object ID, and a table generation time are deducted from the table name OBJ$.

5. The method for restoring data according to claim 3,
wherein among the schema information, an object ID, a column name, a column data type, and size information of the table are deducted from the table name C_OBJ#.

6. The method for restoring data according to claim 1,
wherein the table is a normal table when the schema information includes a flag value of 0x6C and is a deleted table when the schema information includes a flag value of 0x7C.

7. The method for restoring data according to claim 1,
wherein the record is a normal record, which is not deleted, when the record has a flag value of 0x2C, and the record is a deleted record when the record has a flag value of 0x3C.

8. A computer-readable recording medium, on which a program for executing the method defined in the claim 1 in a computer is recorded.

9. An apparatus for restoring data, comprising:
an input unit for receiving a system file from a database;
a processing unit for inquiring a system table included in the system file to deduct schema information about at least one table in the system file, sorting a table having a deleted record among the at least one table based on the schema information, and searching and deducting a data block including the deleted record by means of an object ID of the sorted table; and
an extracting unit for identifying and extracting the deleted record from the deducted data block to restore the deleted record.

10. The apparatus for restoring data according to claim 9,
wherein the database is an oracle database.

11. The apparatus for restoring data according to claim 9,
wherein the processing unit searches and deducts a table name OBJ$ and a table name C_OBJ# included in the system table, and the data restoring system deducts the schema information according to flag values of the deducted table name OBJ$ and the deducted table name C_OBJ#, and
wherein among the schema information, a table name, an object ID, and a table generation time are deducted from the table name OBJ$, and among the schema information, an object ID, a column name, a column data type, and size information of the table are deducted from the table name C_OBJ#.

12. The apparatus for restoring data according to claim 9,
wherein the table is a normal table when the schema information includes a flag value of 0x6C and is a deleted table when the schema information includes a flag value of 0x7C.

13. The apparatus for restoring data according to claim 9,
wherein the record is a normal record, which is not deleted, when the record has a flag value of 0x2C, and the record is a deleted record when the record has a flag value of 0x3C.
